(19) United States
(12) Patent Application Publication
(10) Pub. No.: US 2014/0216326 A1
(43) Pub. Date: Aug. 7, 2014

(54) Method for Constructing Surfboards, River Boards, Kayaks, and Stand Up Paddle Boards

(71) Applicant: Ken Driscoll, Salt Lake City, UT (US)

(72) Inventor: Ken Driscoll, Salt Lake City, UT (US)

(21) Appl. No.: 13/761,769

(22) Filed: Feb. 7, 2013

(51) Int. Cl. B63B 35/79; B05D 1/02; B63B 35/71

(52) U.S. Cl. CPC B63B 35/7909; B63B 35/71; B05D 1/02
USPC 114/347; 441/74; 427/427.6

(57) ABSTRACT

A method and surfboard, river board, kayak, and standup paddleboard with a polyurea force distributing sealing outer coating applied over polystyrene foam shaped or molded cores to provide increased strength and abrasion resistance.

### BACKGROUND OF THE INVENTION

1. Field

This invention relates to methods of construction of Surfboards, River Boards, Kayaks, and Stand up Paddle Boards. In particular, it relates to a method and improved surfboard, river board, kayak and standup paddleboard covered with a polyurea force distributing sealing coating over polystyrene foam shaped or molded cores providing increased strength and abrasion resistance.

2. State of the Art

Surfboards, river boards, kayaks and standup paddleboards are made of foam cores made of polystyrenes, which are synthetic aromatic polymers made from the monomer styrene, a liquid petrochemical. They are a rather poor barrier to oxygen and water vapor and therefore are usually wrapped with fiberglass cloth and covered with an epoxy resin to create more sturdy surfboards, river boards, kayaks and standup paddleboards.

Polystyrene foams often suffer from dimensional instability expanding and contracting with temperature. Thus different polystyrene foams are selected to meet the end use requirements. For surfboards, river boards, kayaks and standup paddleboards, expanded polystyrene (EPS) is often used. EPS is a rigid and tough, closed-cell foam. It is usually white and made of pre-expanded polystyrene beads. EPS is also used for disposable trays, plates, bowls and cups; and for carryout food packaging (including the hinged lid containers popularly know as “clam shells”). Other uses include molded sheets for building insulation and packing material (“peanuts”) for cushioning fragile items inside boxes. Sheets are commonly packaged as rigid panels (size 4 by 8 or 2 by 8 feet in the United States), which are also known as “bead-board”.

Other foam cores are made from extruded polystyrene foam (XPS). XPS consists of closed cells, with improved surface roughness and higher stiffness and reduced thermal conductivity. XPS density ranges from about 28-45 kg/m³. Because of the extrusion manufacturing process, XPS does not require facers to maintain its thermal or physical property performance. Water vapor diffusion resistance (p) of XPS is around 80-250 and so makes it more suitable to wetter environments than EPS.

Conventional boards suffer from poor abrasion resistance and tend to dent when bumped or pounded. They also tend to twist and break when subjected to shock. These conventional boards thus are not suitable for the rigors of running whitewater rivers, where contact with rocks is routine. The method of construction and improved board described below provides a board that can handle the rigors of running white water rivers.

### SUMMARY OF THE INVENTION

A method for constructing an improved surfboard, river board, kayak, stand up paddle board, SUP, and river boards comprising applying a polyurea force distributing coating to a shaped or molded blank foam core of polystyrene that may or may not be first laminated with in epoxy or polyester resin. For direct application, the polyurea is applied to EPS or XPS foam core directly.

For foam cores of styrene laminated in fiberglass using a epoxy or polyester resin, the polyurea is applied as the outer and final coating over then entire board. This coating is not only cosmetic but also alters the polyurea coated board's physical properties. It increases the strength of the polyurea coated board and minimizes denting by distributing contact forces across a wider surface. For example, a conventional epoxy board will break if suspended by the ends and the weight of an adult male is placed on the middle of the epoxy board. Conversely, a similarly suspended polyurea coated board holds the weight of 3 or 4 adult males with no damage to the board.

Nor can a standard constructed epoxy board withstand impacts well, and will crack on impacts with rocks, roots, or other obstacles typically found in river environments. The polyurea coated boards withstand repeated impacts and show a tremendous amount of strength, not only with respect to impacts, alt also in regards to flexation.

It also seals the board and prevents water from entering the foam core, whereas epoxy boards have a tendency to leak and lose buoyancy over time.

The construction process is the same using carbon fiber, or Kevlar or fiberglass. The boards start as an EPS or XPS foam blank. Then it is covered in fiberglass (or the other materials, or a combination thereof) and epoxy resin.

Polyurea is applied using commercially available plural-component proportioning equipment. The polyurea coating is typically an A and B blend of component materials that are applied using specialized equipment that heats up the material, then pressurizes the materials for application using a specialized spray gun. The general reaction for forming a polyurea chain uses the two monomer reactants linked with the urea linkage in the product. Urea or carbamide is an organic compound with the chemical formula (NH₂)₂CO. The molecule has two amine groups (—NH₂) joined by a carbonyl functional group (C═O). In a polyurea, alternating monomer units of isocyanates and amines react with each other to form urea linkages.

Polyurea is a type of elastomer that is derived from the reaction product of an isocyanate component and a synthetic resin blend component through step-growth polymerization. The isocyanate can be aromatic or aliphatic in nature. It can be monomer, polymer, or any variant reaction of isocyanates, quasi-prepolymer or a prepolymer. The prepolymer, or quasi-prepolymer, can be made of an amine-terminated polymer resin, or a hydroxyl-terminated polymer resin.

The resin blend may be made up of amine-terminated polymer resins, and/or amine-terminated chain extenders. The amine-terminated polymer resins will not have any intentional hydroxyl moieties. Any hydroxyls are the result of incomplete conversion to the amine-terminated polymer resins. The resin blend may also contain additives, or non-primary components. These additives may contain hydroxyls, such as pre-dispersed pigments in a polyol carrier. Normally, the resin blend will not contain a catalyst(s). These various compositions will all be referred to as polyurea coatings.

Typical equipment used to apply polyurea has two metering, or proportioning pumps (one for each component) that heat and proportion the isocyanate and polyol resin through heated hoses to the spray gun in a 1:1 ratio. Polyurea needs to be heated to 140° F.-160° F. for optimum processing. Heating the material is usually accomplished with pre-heaters located on the proportioning machine. Heated hoses are then used to maintain the chemicals at the required temperature until they are mixed and applied with the spray gun.

The two materials are kept separate through this entire system until they come together in the gun, where they are mixed and spray applied to the substrate.

Most every commercial polyurea spray guns use impingement-mixing technology to mix the chemicals inside the gun. Other pouring and injection applications can also be incorporated in a variety of different mixing technologies including static and dynamic mix.

Once the two materials come together inside the gun to mix, they begin to react immediately as they mix and exit the spray gun.

The EPS foam generally is covered in fiberglass and carbon fiber embedded in epoxy, at which point the polyurea is applied. Coating the entire board in polyurea gives the strength to withstand almost any environment that the board will be subjected.

Encasing the foam core of polystyrene, with or without fiberglass cloth covered in epoxy resin, provides a force distributing polyurea coating to increase the strength of the finished board. It also seals and protects the foam cores from water penetration to give them increased strength and abrasion resistance.

Polyurea coatings fast reactivity and relative insensitivity to moisture make them useful coatings to seal foam boards. However, the unexpected added benefit of force distribution eliminates the need for stringer reinforcement; thereby providing a lighter surfboard, river board, kayak, stand up paddleboard, and river board. Some polyureas reach strengths of 6000 psi (40 MPa) tensile and over 500% elongation making it a tough coating. If needed, the quick cure time allows many urea coats to be built up quickly for added strength. However, this adds to the weight of the surfboard, river board, kayak, stand up paddleboard, SUP, and river board and is only used for special applications.

The method thus provides an improved surfboard, river board, kayak, and standup paddle board with a polyurea force distributing sealing outer coating applied over polystyrene foam shaped cores to provide increased strength and abrasion resistance

### DESCRIPTION OF THE DRAWINGS

FIG. 1 is perspective view of a cross section of a conventional surfboard.

FIG. 2 is a perspective view of a cross section of an improved surfboard.

### DESCRIPTION OF THE ILLUSTRATED EMBODIMENTS

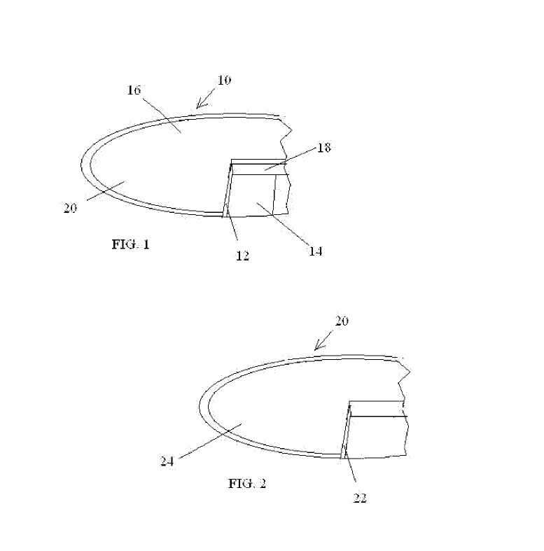

FIG. 1 is perspective view of a cross section of a conventional surfboard 10. It is constructed of an EPS foam core 12 embedded with a PVC or wood stringer 18 for strength reinforcement. The Foam core 12 stringer 18 inner construction is covered with fiberglass cloth 14 embedded in an epoxy resin 16. The finished board is then finished with a polish 20.

FIG. 2 is a perspective view of a cross section of the simplest embodiment of an improved surfboard 20 produced by the present method. An EPS foam core 22 is pressure coated with a layer of polyurea 24 to produce a surfboard of better strength and abrasion resistance without the reinforcing stringers of the conventional surfboard 10.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

I claim:

1. A method for constructing an improved surfboard, river board, kayak, and stand up paddle board comprising applying a polyurea force distributing outer sealing coating to a shaped or molded polystyrene blank foam core that may or may not be first laminated with fiberglass, carbon, or similar fiber materials embedded in epoxy or polyester resin.

2. A method according to claim 1, wherein the shaped blank foam core of styrene is made of EPS or XPS foam.

3. A method according to claim 2, wherein the polyurea coating is applied directly to the shaped blank foam core made of EPS or XPS foam.

4. A method according to claim 1, wherein the polyurea coating is an isocyanate component and a synthetic resin blend component step-growth polymerization material that is heated and then pressure applied to the outer surface with a spray gun

5. A method according to claim 1, wherein multiple layers of polyurea are applied.

6. An improved surfboard, river board, kayak, and stand up paddle board comprising;
a. a shaped or molded polystyrene blank foam core, and
b. a polyurea force distributing outer sealing coating covering the foam core.

7. An improved surfboard, river board, kayak, and standup paddleboard according to claim 6, wherein the shaped polystyrene blank foam core is laminated with in epoxy or polyester resin applied over fiberglass, carbon, or similar cloth materials.

8. An improved surfboard, river board, kayak and standup paddle board according to claim 6, wherein the shaped blank foam core of styrene is made of EPS or XPS foam.

9. An improved surfboard, river board, kayak and standup paddle board according to claim 8, wherein the polyurea coating is applied directly to the shaped blank foam core made of EPS or XPS foam.

10. An improved surfboard, river board, kayak and standup paddle board according to claim 6, wherein multiple layers of polyurea are applied.
